(19) United States
(12) Patent Application Publication
(10) Pub. No.: US 2016/0066602 A1
(43) Pub. Date: Mar. 10, 2016

(54) PAR-FRIED PROCESS FOR BONELESS WHOLE MEAT MUSCLE

(71) Applicants: William J. Smith, Orchard Park, NY (US); Eric Van Zyl, Midhurst (CA)

(72) Inventors: William J. Smith, Orchard Park, NY (US); Eric Van Zyl, Midhurst (CA)

(21) Appl. No.: 14/477,087

(22) Filed: Sep. 4, 2014

(51) Int. Cl. A23L 1/01; A23L 1/31; A22C 17/04

(52) U.S. Cl. CPC A23L 1/0107; A22C 17/04; A23L 1/3103; A23V 2002/00

(57) ABSTRACT

A method of par frying boneless whole meat muscle including trimming boneless whole meat muscle, portioning the boneless whole meat muscle into portions that have a thickness from 0.25 to 1 inch, a width of 0.25-1.5 inches and length of 1-7 inches. The portions are marinated, dusted, battered and breaded. The portions may be par fried in oil at a temperature between 190-200° C. for 25-30 seconds. The portions may then undergo freezing and then may be reheated when desired.

### FIELD OF THE INVENTION

The present invention relates generally to par-fried process for whole muscle. The present invention further relates to methods of cutting and preparing whole meat muscle namely beef cuts for par frying.

### BACKGROUND OF THE INVENTION

Commercial food processing companies provide fast food restaurants and the like with large quantities of several types of par-fried and fully fried food products. Typically these companies are providing poultry in the form of chicken fingers. The consumer requires fast service whereby the restaurant does not have enough time to process and prepare a battered and fried chicken finger from a raw, frozen chicken piece every time such a meal is ordered. Other types of foods such as fish and vegetables also are commonly first batter coated, then breaded, cooked by pan frying or deep frying, and finally frozen requiring the final consumer to finish the cooking either by baking or frying.

As such conventional in-plant processing systems of breaded food products have typically focused on methods for poultry or fish products that can take several forms. For example one method incorporates fresh fish or poultry that is produced by marinating the product with seasonings, applying batter and breading to the batter surfaces and then flash freezing the product. With this type of product the fry time with a conventional fryer exceeds what is acceptable for fast food or counter service restaurants.

With a fully cooked product, the poultry or fish product is marinated by injection to maintain a moist product during convection vapour cooking and it is then pre-dusted, battered, breaded, par-fried and flash frozen. This method addresses the fry time issue as it allows the restaurant to gradually heat the product to a near cooking temperature followed by brief frying for a finished product. This allows for the frying to take place based on product demand, however the finished product is often not considered sufficiently moist and juicy.

Mariantion has been introduced into the process to help address flavour and hydration levels during the various process steps however, because of varying portions, sizes of products, pressures, tumbler speeds, processing times, it is extremely difficult to get a consistent product. This is particularly exhibited for different sizes and or shapes of meat products.

Effective meat processing systems must be able to adapt to a mass production environment simply, fast, at low cost, and with unskilled labour. Therefore an improved solution is required to address the above-mentioned problems.

### SUMMARY OF THE INVENTION

In accordance with an aspect of the present invention there is provided a method of par frying boneless whole meat muscle including trimming boneless whole meat muscle, portioning the boneless whole meat muscle into portions that have a thickness from 0.25 to 1 inch, a width of 0.25-1.5 inches and length of 1-7 inches. The portions are marinated, dusted, battered and breaded. The portions may then be par fried in oil at a temperature between 150-195° C. for 20-50 seconds. The portions may then undergo freezing and then may be reheated when desired.

In accordance with another aspect of the invention the boneless whole muscle meat may come from beef, rabbit, pig, horse, deer elk, moose, bear, kangaroo, emu, ostrich, pheasant, duck or goose and may come from an animal cut such as flank, inside, top sirloin, rump, breast, brisket, sirloin cap and outside round.

In accordance with another aspect of the invention, the portions of boneless whole meat muscle are marinated in a saline solution having sodium content between 14 to 21% with a preferred sodium 17.46 g/100 g solution till the portions double in weight.

Par frying is a process that only partially cooks the product. As such the product is still considered raw and therefore requires further cooking or finishing. By par-frying the portions prior to cooking the boneless whole meat muscle portions, the inherent moisture in the portions can be sealed into the product resulting in a juicier more flavourful product.

Other advantages and aspects of the present invention will become apparent upon review of the drawing and upon reading the following of the invention.

### BRIEF DESCRIPTION OF THE DRAWINGS

In the drawings, embodiments of the invention are illustrated by way of example. It is to be expressly understood that the description and drawings are only for the purpose of illustration and as an aid to understanding, and are not intended as a definition of the limits of the invention.

FIG. 1 illustrates a flow chart diagram in accordance with the process of aspect of the invention.

### DETAILED DESCRIPTION

Features of the systems, devices, and methods described herein may be used in various combinations. The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

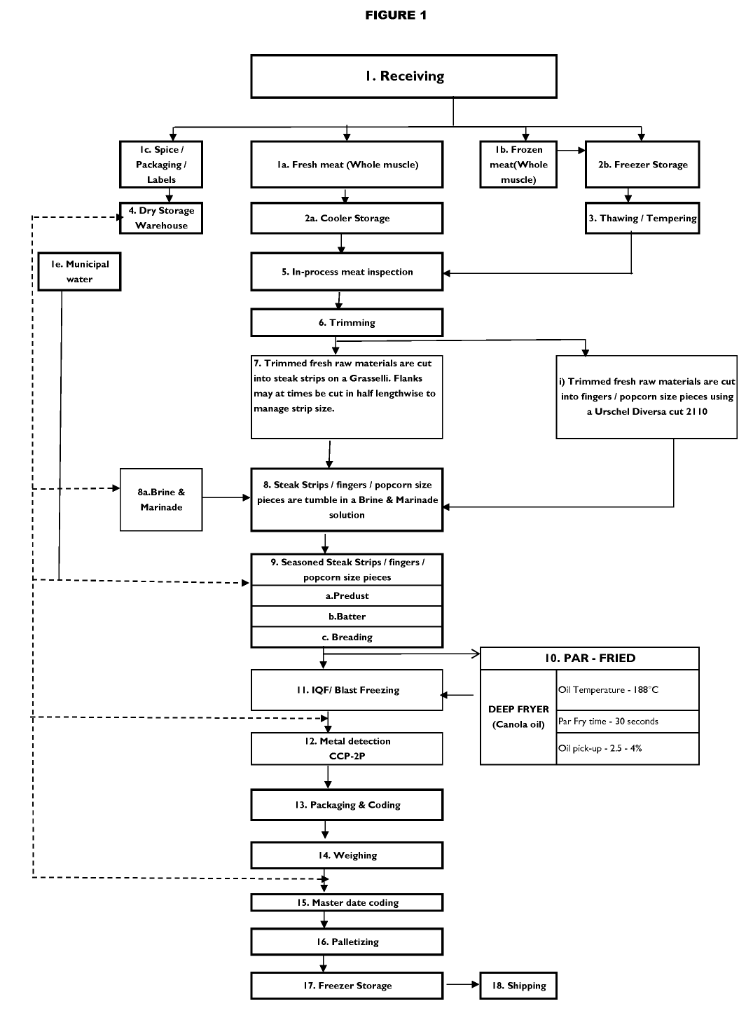

Referring to FIG. 1 there is provided a method of par frying boneless whole meat muscle including trimming boneless whole meat muscle, portioning the boneless whole meat muscle into portions that have a thickness from 0.25 to 1 inch, a width of 0.25-1.5 inches and length of 1-7 inches. The portions are marinated, dusted, battered and breaded. The portions may then be par fried in oil at a temperature between 190-200° C. for 25-30 seconds. The portions may then undergo freezing and then may be reheated when desired.

Boneless whole meat muscle may be purveyed from a variety of animals such as cow, rabbit, pig, horse, deer elk, moose, bear, kangaroo, emu, ostrich, pheasant, duck and goose. Boneless whole meat muscle is primal cuts, mechanically unadulterated and is not formed. The nature of whole muscle makes products produced from these cuts a healthy choice. Typically, boneless whole muscle cuts come from animal cuts such as flank, inside, top sirloin, rump, breast, brisket, sirloin cap and outside round.

In the instant invention whole meat muscle such as beef is trimmed fresh or is frozen and thawed and tempered and then trimmed. The portioning process of the instant invention varies depending on what type of portion is desired. The portion size is flexible and depends on the desired serving size and desired use such as appetizer use, meal supplement (salad topping), or center of the plate applications. Typically boneless whole meat muscle may be portioned into strips, fingers or dices/bites by way of example only.

For example beef cuts may be sliced using either a Grasselli raw meat slicer, or other appropriate food-grade slicer, into specified thicknesses that may range from ¼-½ inch depending on portion and specification.

Beef cuts may be face-sliced perpendicular to the thickness of the beef cut with the vertical orientation of the slice ranging across the shorter of the cut's dimension. Typically beef strip portions will be as wide as the thickness of the cuts and as long as the range of widths of the cut. Therefore the slices will be similar to “small belts” of ¼-½ inch thick, approximately 1.0-1.5 inches wide (given by the thickness of the beef cut), and range from approximately 2-7 inches (given the width of the beef cut).

Portioning the beef cuts into strips includes orienting a beef steak with the grain horizontal to a cutting mechanism such that cutting is as one would slice meat for table consumption with a knife. These slices are thus cut across the grain. Slice thickness can be varied from 0.25″-1.00″. When portioning beef cuts into fingers or dices, one may utilize an Urschel dicer or similar piece of equipment whereby the meat is sliced into 0.5″×0.5″×2″-3″ fingers (dimensions may vary from 0.25″×0.25″ to 1.0″×1.0″ in the cross sectional dimension, and lengths from 1.0″-6.0″ in finger length), or diced (bites) into 0.5″×0.5″×0.5″ dices (dimensions may vary from 0.25″×0.25″×0.25″ to 1.0″×1.0″×1.0″ dices).

The shapes resulting from the portions may be controlled by the natural size of the cut of muscle. Specifically the thickness of the portion is a natural by-product of the size of muscle-cut processed through the slicer. This gives the strip product a natural aspect.

Size sorting the portion is feasible where desired. Typically this achieved by cutting beef cuts into strips as described above using an Urchel Diverse cut 2110. The sized beef strips can then be transferred via an incline conveyor to a sorting table that is equipped with a built-in grading screen.

Grading screens are interchangeable and can vary in size aperture from ¼-1″ square. Undersize strips pass through the screen aperture into a stainless steel bin for further processing. Spec sized strips however accumulate on the screen and are packed off for further process.

Once the beef cuts are portioned, they are marinated in a variety of solutions and flavours as set out in Table 1. Solutions range from saline only to sea-salt saline level to a variety of flavored marinades. Typically the saline solution contains sodium in the range of 14 to 21% with a preferable saline solution of 17.46 g/100 g. The boneless whole beef muscle can also be marinated prior to portioning.

Marinating the whole muscle or portions may occur in a vacuum tumbler. Marinating the portions not only imparts flavour but improves yield enhancement and moisture content. Specifically marinating the portions acts as a hydration process that increases the net weight of the beef or muscle portions by approximately 100% and therefore overall yield. The increase in hydration may result in the overall amount of meat muscle content. Variations in formulation can affect the total hydration ratios namely total muscle meat versus muscle meat plus marinate pick up.

Once the portions have been marinated, they are dusted typically with a flour mixture and are breaded and or battered with a range of breading options from regular flour to gluten free for example only. Batter is defined as a mixture usually consisting of flour mixed with liquid ingredients and other dry ingredients, which vary depending on the recipe. The liquid ingredients may include eggs, water, or milk and other dry ingredients may include salt, baking powder or baking soda, and sugar. Batter is usually liquid enough to be poured, unlike dough, which is much thicker and must be kneaded and formed into a shape by hand.

Breading is defined as the process of covering food with bread crumbs, cracker crumbs or also nuts, before it is cooked to improve the flavour and texture of the food after it has been prepared. Once the food is breaded, it is then baked, sautéed, broiled, or deep-fried to create a crispy, crunchy crust that covers the food. If the food being prepared is already moist, it is dredged in flour, dipped in eggs that have been beaten into a smooth, liquid consistency, and then breaded with the dried bread or crackers. If however, the food needs moisture it is advisable to first coat the food lightly with the beaten eggs and then dredge it in flour followed by another coating of the beaten eggs and then the final crumb coating. Always lightly shake off any excess flour after the food is dredged in flour. If desired, once the food is coated it can be air-dried on a cooking rack for 15 to 20 minutes to enable the crumbs to adhere more securely to the food.

A variety of flavourings and seasonings may be added to the dusting and breading process. Dusting, breading and battering the portions may occur individually or in combination with one another.

TABLE 1

| Protein | Cut | Marinade | Marinade | Breading |
|---|---|---|---|---|
| Beef | | | | |
| Any whole | | | | |
| muscle cut | | | | |
| exampled but not | | | | |
| limited to these | | | | |
| | | Savory | Steakhouse | Southern fried |
| | Tri Tip | Chipolte | Applewood Smoked | Beer Batter |
| | Brisket | Lemon Pepper | Teryaki | Gluten Free |
| | Top Sirloin | Bourbon Bbq | Jerk | Multi Grain |
| Pork | Shoulder | Classic (sea salt) | Carne Asada | Whole Wheat |
| | Belly | Stout | Moroccan | Panko |
| | Loin | Texas Bbq | Peppercorn | Corn Flake |
| Chicken | Fillet | Carolina Bbq | Chile | Cornmeal |
| | Breast | Kansas City Bbq | Ancho | Rice Flour |
| | Thigh | Siracha | Citrus Honey | Parmesan |
| Turkey | Fillet | Ghost Pepper | Honey Garlic | Coconut |
| | Breast | Salt and Pepper | Garlic | Tempura |
| | Thigh | Cajun Butter | Hot Mustard | |
| Bison | Flank | Cajun | Memphis Rub | |
| | Insides | Butter Chicken | Sweet & Sour | |
| | Tri Tip | Italian | Cajun Blackened | |
| | Top Sirloin | Tex Mex | | |
| Wild Boar | Shoulder | Jalapeno | | |
| | Loin | Rosemary | | |
| | Belly | Tomato Basil | | |
| | | Spicy Ceasar | | |
| | | Sweet and Smokey | Malayasian | |
| | | Halal variants | Creole | |
| | | Kosher variants | Peri Peri | |
| | | Buffalo (chicken)Wing | Berbere | |

Portions may be par fried in hot vegetable oil, such as canola oil at a temperature between 150-195° C. for 20-50 seconds in a deep fryer. Through the par frying process, the portions usually pick up 3-5% of the vegetable oil thereby not imparting an oily taste or mouth feel to the final product. Typically par frying partially cooks the portions thereby allowing the end consumer to easily re-heat the portion in a reduced cook time so as to provide increased convenience and preparation cost savings.

Once par fried the portions are quick or flash frozen to preserve freshness and may be packaged for distribution. All types of portions may be re-heated by the end consumer in conventional or convectional ovens, deep fryers, microwaves or barbeques.

### Example 1

### Steak Strip/Finger/Dice/Bites

Whole muscle meat is denuded and frozen.
Frozen product is tempered to internal temperature of 26-28 F.
Tempered product is placed in a Urschel Diversa 2110 which is equipped with knives that could be adjusted to slice various sizes and shapes
Diced/sliced products are transferred via an incline conveyor onto a sorting table that is equipped with a built-in grading screen with interchangeable size aperture from ¼-1″ square
Undersize pieces pass through the screen aperture into a stainless steel bin for further processing.
Spec sized product that accumulate on the screen are accumulated and placed in a vacuum tumbler
Brine and water are added to the tumbler as per formulation
Marinated product is transferred via a conveyor to the pre-dusted, battered and breaded stage.
Breaded product is par fried at a temperature of 190-200° C. for 25 to 30 seconds, then packaged into labelled retail units based on net weight requirements, mastered, palletized and placed into the freezer until frozen.
Frozen finished goods are shipped for storage.

It will be appreciated by those skilled in the art that other variations of the embodiments described herein may also be practiced without departing from the scope of the invention. Other modifications are therefore possible.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

We claim:

1. A method of par frying boneless whole meat muscle comprising:
a) trimming boneless whole meat muscle;
b) portioning the boneless whole meat muscle into portions have a thickness from 0.25 to 1 inch, a width of 0.25-1.5 inches and length of 1-7 inches;
c) marinating the portions;
d) dusting, battering and breading the portions;
e) par frying the portions in oil at a temperature between 190-200° C. for 25-30 seconds; and
f) freezing the portions.

2. A method of par frying boneless whole meat muscle as claimed in claim 1 wherein the boneless whole meat muscle is selected from an animal cut group consisting of flank, inside, top sirloin, rump, breast, brisket, sirloin cap, outside round, eye of round, tri tip, bottom sirloin ball tip, top sirloin cap, tenderloin, strip loin, brisket, skirt (inside and outside), chuck (shoulder, pectoral, shoulder clod, boneless top and bottom blade, cross rib, flat iron, blade mock tender, rib eye, and sirloin tip.

3. A method of par frying boneless whole meat muscle as claimed in claim 1 wherein the boneless whole meat muscle is selected from an animal group consisting of beef, rabbit, pig, horse, deer elk, moose, bear, kangaroo, emu, ostrich, pheasant, duck and goose.

4. A method of par frying boneless whole meat muscle as claimed in claim 1 wherein the boneless whole meat muscle is fresh, frozen, thawed or tempered.

5. A method of par frying boneless whole meat muscle as claimed in claim 1 wherein the boneless whole meat muscle is portioned into strips, fingers or dice portions.

6. A method of par frying boneless whole meat muscle as claimed in claim 1 wherein the boneless whole meat muscle is portioned into strip portions from 0.25″-7.00″ in length.

7. A method of par frying boneless whole meat muscle as claimed in claim 1 wherein the boneless whole meat muscle is portioned into finger portions from 0.25″×0.25″ to 1.0″×1.0″ in cross sectional dimension, and lengths from 1.0 inch-6.0 inches in length.

8. A method of par frying boneless whole meat muscle as claimed in claim 1 wherein the boneless whole meat muscle is portioned into dice portions from 0.25″×0.25″×0.25″ to 1.0″×1.0″×1.0″ dices.

9. A method of par frying boneless whole meat muscle as claimed in claim 1 wherein the portions of boneless whole meat muscle are marinated in a saline solution having a sodium content of 14 to 21% till the portions double in weight.

10. A method of par frying boneless whole meat muscle as claimed in claim 1 wherein the portions of boneless whole meat muscle are par-fried vegetable oil wherein the portions absorb 3.0-5.0% of their weight in vegetable oil.

11. A method of par frying boneless whole meat muscle as claimed in claim 1 wherein the method further comprises reheating the portions by deep frying, convention or convection oven, microwave or barbeque grill.

12. A method of par frying boneless whole beef muscle comprising:
a) trimming boneless whole beef muscle;
b) portioning the boneless whole beef muscle into sliced portions have a thickness from 0.25 to 1 inch, a width of 0.25-1.5 inches and length of 1-7 inches;
c) marinating the sliced portions;
d) dusting, battering and breading the portions;
e) par frying the portions in oil at a temperature between 190-200° C. for 25-30 seconds; and
f) freezing the portions.
